(19) United States
(12) Patent Application Publication
(10) Pub. No.: US 2023/0045471 A1
(43) Pub. Date: Feb. 9, 2023

(54) Dynamic Sun Shielding System for a Motor Vehicle and Method for Dynamic Sun Shielding Via Seat Adjustment

(71) Applicants: Hyundai Motor Company, Seoul (KR); Kia Corporation, Seoul (KR)

(72) Inventor: Joris Burkholz, Darmstadt (DE)

(21) Appl. No.: 17/457,289

(22) Filed: Dec. 2, 2021

(30) Foreign Application Priority Data
Aug. 6, 2021 (DE) 102021208588.1

(51) Int. Cl. B60J 3/00; B60N 2/02; B60N 2/12; B60N 2/16

(52) U.S. Cl. CPC B60J 3/00; B60N 2/0244; B60N 2/12; B60N 2/16; B60R 1/062

(57) ABSTRACT

An embodiment method for dynamic sun shielding via seat adjustment in a motor vehicle includes determining if an eye region of a vehicle occupant is currently or foreseeably exposed to glaring light incident through a window of the motor vehicle, and adjusting a vehicle seat occupied by the vehicle occupant such that the glaring light is at least reduced in the eye region of the vehicle occupant, the determining and adjusting being performed without input of the vehicle occupant.

### CROSS-REFERENCE TO RELATED APPLICATIONS

The present application claims the benefit of German Patent Application No. 102021208588.1, filed on Aug. 6, 2021, which application is hereby incorporated herein by reference.

### TECHNICAL FIELD

The present invention pertains to a method for dynamic sun shielding via seat adjustment in a motor vehicle, a dynamic sun shielding system for a motor vehicle and a motor vehicle with such a sun shielding system.

### BACKGROUND

A sun visor is a component of an automobile located on the interior just above or on the windshield. They are designed with a hinged flap that is usually adjustable by hand to help shade the eyes of drivers and passengers from the glare of sunlight. In particular situations, it may be necessary or desired to change the position and/or orientation of the sun visor rather frequently in order to achieve satisfactory coverage of the eyes. For example, it may happen that the sun is relatively low on the horizon (during winter, sunset or sunrise etc.) and shines frontally on the vehicle, which may require constant shifting of the visor due to the movement of the sun across the horizon and/or due to repeated directional changes of the vehicle with respect to the sun.

Robert Bosch GmbH has developed a sophisticated high-end system called “Virtual Visor,” which comprises a single transparent LCD panel, a driver-facing camera with AI facial detection and a corresponding analysis and tracking software. The system is conceived to replace the traditional vehicle sun visor completely by utilizing intelligent algorithms to intuitively block the sun's glare and not the view of the road ahead. To this end, only a minimized and dynamically adapted portion of the LCD panel is darkened to block sun, while the remaining part of the panel remains transparent.

### SUMMARY

Hence, there is a need to find simpler and more pragmatical solutions for dynamically shielding vehicle occupants from glaring light.

To this end, embodiments of the present invention provide a method in accordance with claim 1, a dynamic sun shielding system in accordance with claim 9 and a motor vehicle in accordance with claim 15.

According to one embodiment of the invention, a method for dynamic sun shielding via seat adjustment in a motor vehicle comprises determining, by a determination unit of the motor vehicle, if an eye region of a vehicle occupant is currently and/or foreseeably exposed to glaring light incident through a window of the motor vehicle, and adjusting, by a seat control unit of the motor vehicle, a vehicle seat occupied by the vehicle occupant such that the glaring light is at least reduced in the eye region of the vehicle occupant.

According to another embodiment of the invention, a dynamic sun shielding system for a motor vehicle comprises a determination unit configured to determine if an eye region of a vehicle occupant is currently and/or foreseeably exposed to glaring light incident through a window of the motor vehicle, and a seat control unit configured to adjust a vehicle seat occupied by the vehicle occupant such that the glaring light is at least reduced in the eye region of the vehicle occupant.

According to yet another embodiment of the invention, a motor vehicle comprises a dynamic sun shielding system according to embodiments of the invention.

One embodiment of the present invention moves the eye region of the vehicle occupant that is exposed to sunlight or other glaring lights away from the light beam and into a shadow region of the interior space, e.g., behind a sun visor, by adjusting the seat of the vehicle occupant appropriately. The seat may be, for example, an electric seat provided with suitable actuators adapted to change the seat's height, position, orientation, inclination and so on. For example, the seat may be raised in order to move the eyes of the occupant back into the shadow behind the sun visor when the sun goes down in front of the vehicle. In that vein any blinding or otherwise annoying light may be shielded from the vehicle occupant, e.g., during sunset or sunrise, in winter times, when driving uphill, changing direction, etc. The embodiments of the present invention thus increase driving safety and convenience on a general level by avoiding the need to continuously adapt a sun visor position while driving. In particular, vehicle drivers suffer less disturbance and are better able to concentrate on the driving.

It is understood that the term “vehicle” or “vehicular” or other similar term as used herein is inclusive of motor vehicles in general such as passenger automobiles including sports utility vehicles (SUVs), buses, trucks, various commercial vehicles, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Advantageous embodiments and improvements of the present invention are found in the subordinate claims.

According to an embodiment of the invention, the seat control unit may be configured to change a seat height, a seat position, a seat inclination and/or a seat orientation of the vehicle seat.

For example, a height increase will lower the shadow of a sun visor falling on the face of a vehicle occupant. The seat can be shifted upwards until the shadow falls at least below the eyes of the occupant. Additionally, or alternatively, a horizontal seat position may be changed, e.g., the seat may be shifted forwards. Other variants may comprise adjusting the inclination of a back rest and/or revolving a seat clockwise or counterclockwise.

According to an embodiment of the invention, the system may further comprise an interior camera configured to monitor at least the eye region of the vehicle occupant. The determination unit may be configured to measure a shadow falling on the eye region of the vehicle occupant by using camera data of the interior camera.

The camera may be provided within the passenger cabin of the vehicle for this particular purpose. However, the system may also utilize cameras that are already provided in the vehicle, e.g., as part of advanced driver assistance systems and/or autonomous driving applications. The camera may be adapted to monitor the eyes and/or the eye region of one or several occupants (a driver, a co-driver, a backseat passenger, etc.). The camera however may also track the heads of the occupants. For example, a distance between the eyes and a lower and/or lateral border of the shadow of a sun visor or other structure within the vehicle may be measured based on the camera data and then fed into a decision algorithm of the present system, which then decides if and how to adjust the respective occupant's seat.

It is to be understood however that not only optical cameras can be used for the above purpose but that also different kinds of cameras (e.g., IR cameras) or sensors (e.g., heat sensors) may be utilized to monitor the eye region and/or the head of an occupant and to measure and/or track a shadow across that region.

According to an embodiment of the invention, the determination unit may be configured to assess vehicle position, vehicle orientation, vehicle inclination, traveling direction, navigation data, environmental data, weather data and/or sun position.

Thus, the presently described methodology is not limited to actual measurements of incident light and shadows but could additionally, or alternatively, also use additional inputs.

For example, knowledge about a current traveling direction may be utilized in combination with information on the current position/direction of the sun (e.g., by using navigation data, date, time, etc.). In this vein, it is also possible to pro-actively adapt the seat configuration when the vehicle approaches a possibly blinding or otherwise uncomfortable situation (e.g., at a crossing before turning left/right into the direction of the sun).

According to an embodiment of the invention, the determination unit may be configured to continuously monitor current and/or imminent exposure of the eye region of the vehicle occupant. The seat control unit may be configured to continuously and/or incrementally adjust the vehicle seat accordingly.

Hence, seat adjustments can be performed continuously and very slowly to avoid any distraction or discomfort of an occupant, in particular of the driver. Adjustments may also be executed in very small increments to approximate an almost continuous adjustment such that an occupant will basically not notice the adjustment or at least will not feel any discomfort or distraction. The seat adjustment may also be started in advance of an anticipated driving situation, e.g., prior to a turn at a crossroad where the vehicle turns in the direction of the setting/rising sun.

According to an embodiment of the invention, the seat control unit may be configured to adjust the vehicle seat such that an operating distance between a selected body part of the vehicle occupant and an operating element of the motor vehicle stays substantially constant during adjustment.

Adjusting the seat should not lead to any uncomfortable or even safety-critical sitting position/orientation (e.g., headroom too low, visibility not sufficient, uncomfortable distance between occupant and steering wheel and/or pedals). For example, the seat adjustment should not put the seat into any dangerous position where the driver cannot see the street anymore due to increased seat height etc. In order to avoid such a situation, embodiments of the present system and method may restrict any seat movement or adjustment to stay below certain thresholds and/or maximal values of change. Moreover, the rate of change may be limited.

Furthermore, the employed algorithm may adjust several parameters of the seat configuration at the same time. To give an example, the system may not only include individual adjustments of a seat height but may additionally adapt the position, orientation and/or inclination of the seat at the same time in a multi-dimensional approach in order to keep the occupant comfortable and safe.

In one particular example, the seat of a driver may be moved upwards and slightly forwards in order keep the distance between the hip-point (H-point) of the driver and the pedals (gas, brake etc.) more or less constant. The hip-point is the theoretical, relative location of an occupant's hip and is frequently used in vehicle design, automotive design and vehicle regulation. The hip-point may specifically refer to the pivot point between the torso and upper leg portions of the body (this may be measured, for example, using the hip joint of a 50th percentile occupant viewed laterally).

According to an embodiment of the invention, the determination unit may be configured to monitor movement of a head of the vehicle occupant. The seat control unit may be configured to at least delay adjustment of the vehicle seat for a given delay time in case that rapid movements of the head are determined fulfilling predefined criteria.

In that vein, constant or unwanted changes of the seat configuration are avoided that could otherwise be triggered due to fast head motions or the like, e.g., movements occurring when the occupant listens to music, turns the head to look into the mirrors, to the back or to watch the outside, when the occupant sneezes etc. The system thus may react only after a certain delay in case certain movements of the head are detected. Suitable criteria may be defined in advance that can be used to assess whether such a situation is occurring or not. For example, typical motion sequences may be recognized based on recurring movement patterns.

According to an embodiment of the invention, the system may further comprise a mirror control unit configured to adjust a rear and/or side mirror of the vehicle according to the seat adjustment. The method may correspondingly comprise adjusting the rear and/or side mirror of the vehicle according to the seat adjustment.

In case that the seat is adjusted in position, orientation and/or inclination, the mirrors might need small adjustments for optimal viewing conditions. The present embodiment now adapts the configuration of the mirrors automatically to the respective seat adjustment in order to keep an optimal mirror orientation at any time.

The invention will be explained in greater detail with reference to exemplary embodiments depicted in the drawings as appended.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. In the figures, like reference numerals denote like or functionally like components, unless indicated otherwise.

FIG. 1 shows a side view of a person driving a vehicle and of a shadow wandering over the person's face due to the movement of the sun.

FIG. 2 shows the situation of FIG. 1 using a method for dynamic sun shielding via seat adjustment according to an embodiment of the invention.

FIG. 3 shows another driving situation using a method for dynamic sun shielding according to an embodiment of the invention.

FIG. 4 schematically depicts a motor vehicle with a dynamic sun shielding system according to an embodiment of the invention.

FIG. 5 shows a flow diagram of the method for dynamic sun shielding as used in FIGS. 2 and 3.

Although specific embodiments are illustrated and described herein, it will be appreciated by those of ordinary skill in the art that a variety of alternate and/or equivalent implementations may be substituted for the specific embodiments shown and described without departing from the scope of the present invention. Generally, this application is intended to cover any adaptations or variations of the specific embodiments discussed herein.

The following reference elements may be used in connection with the drawings to describe the various embodiments:
1 dynamic sun shielding system
2 determination unit
3 seat control unit
4 mirror control unit
5 vehicle seat
6 mirror
7 shadow
8 head
9 sun
10 motor vehicle
11 sun visor
12 interior camera
13 operating element
14 hip-point
15 light
16 eye region
M method
M1-M3 method steps

### DETAILED DESCRIPTION OF ILLUSTRATIVE EMBODIMENTS

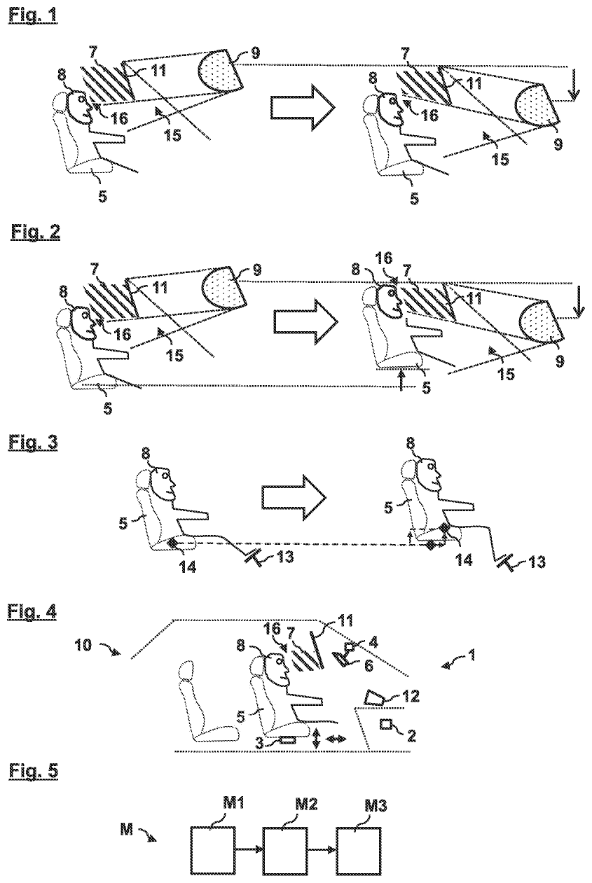

FIG. 1 schematically depicts a side view of a person driving a vehicle and of a shadow 7 wandering over the person's head 8 and eye region 16 due to the movement of the sun 9.

The driver may be driving for a longer time in the same or similar direction in the evening while the sun 9 goes down and slowly approaches the horizon. As can be seen on the left in FIG. 1, the head 8 of the driver, and in particular the eye region 16, may at first still be covered by a sun visor's 11 shadow 7 from glaring light 15 coming from the sun 9. However, as the sun 9 goes further down on its way to the horizon, the shadow 7 will also move slowly upwards on the head 8 of the driver. Eventually, the eye region 16 of the driver will get exposed to the sunlight 15, as can be seen on the right of FIG. 1. The driver then may need to manually readjust the sun visor 11 to avoid getting blinded by the sun 9. As the sun 9 goes further down, the driver may have to repeatedly readjust the sun visor 11. This may be particularly inconvenient if the vehicle travels on a road with frequent changes in inclination or frequent turns.

With reference to FIGS. 2 to 5, embodiments of the present invention are described that overcome these drawbacks in a very effective yet simple way. FIG. 2 shows the situation of FIG. 1 using a method M for dynamic sun shielding via seat adjustment according to an embodiment of the invention. FIG. 5 shows a flow diagram of this method M. FIG. 3 depicts another driving situation using such a method M, while FIG. 4 schematically shows a motor vehicle 10 with a dynamic sun shielding system 1 according to an embodiment of the invention.

The system 1 includes a determination unit 2 configured to determine if the eye region 16 of the vehicle occupant is currently and/or foreseeably exposed to glaring light 15 incident through a window of the motor vehicle 10. The determination unit 2 may be part of a computing and processing system of the vehicle and may comprise suitable hardware and software for this purpose.

In order to assess whether the eye region 16 of the vehicle occupant is currently exposed to light or not, the system 1 further comprises an interior camera 12 configured to monitor at least the eye region 16 of the vehicle occupant. The determination unit 2 is configured to receive corresponding camera data taken by the interior camera 12 and to measure a shadow 7 falling on the eye region 16 of the vehicle occupant by using the camera data of the interior camera 12.

The determination unit 2 may not only be able to assess a current position, border and/or areal extension of the shadow 7 on the eye region 16 of the occupant but may also be able to determine any movement of the shadow 7. The determination unit 2 may thus be able to estimate, based on the movement of the shadow 7, whether the eye region 16 of the occupant will be exposed in the near future.

More generally, the determination unit 2 may be configured to continuously monitor current and/or imminent exposure of the eye region 16 of the vehicle occupant, e.g., based on the camera data. However, the determination unit 2 is not restricted to the information acquired by the camera 12.

In addition, the determination unit 2 may be configured to assess various other aspects that may be relevant for the current and/or imminent situation with regards to incident light. Amongst others, the determination unit 2 may be configured to assess vehicle position, vehicle orientation, vehicle inclination, traveling direction, navigation data, environmental data, weather data and/or sun position and so on. To this end, the determination unit 2 may be communicatively coupled to and/or may be part of respective vehicle systems like navigation systems, advanced assisted driving systems, automatic/autonomous driving systems and so on.

The system 1 further comprises a seat control unit 3 configured to adjust a vehicle seat 5 occupied by the vehicle occupant such that the glaring light 15 is at least reduced in the eye region 16 of the vehicle occupant. The vehicle seat 5 may particularly be an electrically actuated seat, the actuators (not shown) being controlled by the seat control unit 3. The seat control unit 3 is thus able to change amongst others a seat height, a seat position, a seat inclination and a seat orientation of the vehicle seat 5. By suitable combined adjustment of some or all of these parameters, the seat control unit 3 can continuously and/or incrementally adjust the vehicle seat 5 in order to keep the eyes of the occupant out of the glaring light 15 as far as possible and with minimal disturbances for the occupant.

With reference to FIG. 5, the method M correspondingly comprises under M1 determining if the eye region 16 of the vehicle occupant is currently and/or foreseeably exposed to glaring light 15, under M2 adjusting the vehicle seat 5 occupied by the vehicle occupant such that the glaring light 15 is at least reduced in the eye region 16 of the vehicle occupant and under M3 adjusting the rear and/or side mirror 6 of the motor vehicle 10 according to the seat adjustment.

FIG. 2 shows a simple example in this regard, in which the vehicle seat 5 is shifted slightly upwards to move the eye region 16 of the occupant out of the glaring light (or to keep the eye region 16 in the shadow 7). In FIG. 3 on the other hand, a combination of upward and forward movement is used to keep an operating distance between a selected body part of the vehicle occupant and an operating element 13 substantially constant during adjustment. In the shown example, the distance between the hip-point 14 of the vehicle occupant and the operating element 13 (in this case a pedal) is kept constant in order to avoid any uncomfortable situation for the occupant.

Referring again to FIG. 4, the system 1 further comprises a mirror control unit 4 configured to adjust a rear and/or side mirror 6 of the motor vehicle 10 according to the seat adjustment. Hence, the mirrors 6 might get small automatic adjustments when the seat configuration is changed.

In order to avoid undesired movements of the vehicle seat 5 in case of sudden or rapid movements of the occupant's head 8, the determination unit 2 may be configured to monitor movement of the head 8 and the seat control unit 3 may be configured to at least delay adjustment of the vehicle seat 5 for a given delay time in case that rapid movements of the head 8 are determined fulfilling predefined criteria.

Due to the above provisions, the described system is able to increase convenience of the vehicle occupants on long journeys. The system also increases safety during driving as the likelihood for the driver to get distracted and/or blinded by the sun is lowered significantly.

In the foregoing detailed description, various features are grouped together in one or more examples with the purpose of streamlining the disclosure. It is to be understood that the above description is intended to be illustrative, and not restrictive. It is intended to cover all alternatives, modifications and equivalents of the different features and embodiments. Many other examples will be apparent to one skilled in the art upon reviewing the above specification. The embodiments were chosen and described in order to explain the principles of the invention and its practical applications, to thereby enable others skilled in the art to utilize the invention and various embodiments with various modifications as are suited to the particular use contemplated.

What is claimed:

1. A method for dynamic sun shielding via seat adjustment in a motor vehicle, the method comprising:
determining if an eye region of a vehicle occupant is currently or foreseeably exposed to glaring light incident through a window of the motor vehicle; and
adjusting a vehicle seat occupied by the vehicle occupant such that the glaring light is at least reduced in the eye region of the vehicle occupant, the determining and adjusting being performed without input of the vehicle occupant.

2. The method according to claim 1, wherein adjusting comprises changing a seat height, a seat position, a seat inclination or a seat orientation of the vehicle seat.

3. The method according to claim 1, wherein determining comprises measuring a shadow falling on the eye region of the vehicle occupant by using an interior camera of the motor vehicle.

4. The method according to claim 1, wherein determining comprises assessing vehicle position, vehicle orientation, vehicle inclination, traveling direction, navigation data, environmental data, weather data or sun position.

5. The method according to claim 1, wherein determining comprises continuously monitoring current or imminent exposure of the eye region of the vehicle occupant and wherein adjusting comprises continuously or incrementally adjusting the vehicle seat accordingly.

6. The method according to claim 1, wherein the vehicle seat is adjusted such that an operating distance between a selected body part of the vehicle occupant and an operating element of the motor vehicle stays substantially constant during adjustment.

7. The method according to claim 1, wherein the determining comprises monitoring movement of a head of the vehicle occupant and wherein the adjusting comprises delaying for a given delay time to determine whether rapid movements of the head fulfill predefined criteria.

8. The method according to claim 1, further comprising adjusting a rear or side mirror of the motor vehicle according to the vehicle seat adjustment.

9. A dynamic sun shielding system for a motor vehicle, the system comprising:
a processor configured to determine if an eye region of a vehicle occupant is currently or foreseeably exposed to glaring light incident through a window of the motor vehicle; and
a seat controller configured to adjust a vehicle seat occupied by the vehicle occupant such that the glaring light is at least reduced in the eye region of the vehicle occupant.

10. The system according to claim 9, wherein the seat controller is configured to change a seat height, a seat position, a seat inclination or a seat orientation of the vehicle seat.

11. The system according to claim 9, further comprising an interior camera configured to monitor at least the eye region of the vehicle occupant, wherein the processor is configured to measure a shadow falling on the eye region of the vehicle occupant by using camera data of the interior camera.

12. The system according to claim 9, wherein the processor is configured to assess vehicle position, vehicle orientation, vehicle inclination, traveling direction, navigation data, environmental data, weather data or sun position.

13. The system according to claim 9, wherein the processor is configured to continuously monitor current or imminent exposure of the eye region of the vehicle occupant, wherein the seat controller is configured to continuously or incrementally adjust the vehicle seat accordingly.

14. The system according to claim 9, wherein the seat controller is configured to adjust the vehicle seat such that an operating distance between a selected body part of the vehicle occupant and an operating element of the motor vehicle stays substantially constant during adjustment.

15. The system according to claim 9, wherein the processor is configured to monitor movement of a head of the vehicle occupant, wherein the seat controller is configured to delay adjustment of the vehicle seat for a given delay time when it is determined that rapid movements of the head fulfill predefined criteria.

16. The system according to claim 9, further comprising a mirror controller configured to adjust a rear or side mirror of the motor vehicle according to the vehicle seat adjustment.

17. A vehicle comprising:
a vehicle body;
a vehicle seat disposed in the vehicle body;
a sun visor disposed in an interior of the vehicle and configured to shield an eye region of an occupant of the vehicle;
a processor installed in the vehicle body and configured to determine if the eye region of the occupant is currently or foreseeably exposed to glaring light incident through a window of the vehicle; and
a seat controller configured to adjust the vehicle seat occupied by the occupant such that the glaring light is at least reduced in the eye region of the occupant.

18. The vehicle according to claim 17, wherein the seat controller is configured to change a seat height, a seat position, a seat inclination or a seat orientation of the vehicle seat.

19. The vehicle according to claim 17, further comprising an interior camera configured to monitor at least the eye region of the occupant, wherein the processor is configured to measure a shadow falling on the eye region of the occupant by using camera data of the interior camera.

20. The vehicle according to claim 17, wherein the processor is configured to assess vehicle position, vehicle orientation, vehicle inclination, traveling direction, navigation data, environmental data, weather data or sun position.
